(19) United States
(12) Patent Application Publication
(10) Pub. No.: US 2004/0218672 A1
(43) Pub. Date: Nov. 4, 2004

(54) Video transmission system video transmission unit and methods of encoding decoding video data

(76) Inventors: David Ronald Bourne, Newbury (GB); Paola Marcella Hobson, Alton (GB)

Correspondence Address: Motorola Inc, Intellectual Property Department, Law Department, 1303 E Algonquin Road, Schaumburg, IL, 60196, US

(21) Appl. No.: 10/483,201

(22) PCT Filed: Jul. 11, 2002
(86) PCT No.: PCT/EP02/07875

(30) Foreign Application Priority Data
Jul. 11, 2001 (GB) 0116928.3

(51) Int. Cl. H04N 7/12

(52) U.S. Cl. 375/240.12; 375/240.13; 375/240.01; 375/240.25

(57) ABSTRACT

A video transmission system (400) includes a plurality of video transmitters (420, 430, 440), each video transmitter transmitting at least one respective video image. At least one video receiver (410) receives video images from the video transmitters. The at least one video receiver includes a plurality of frame stores (412, 414, 416) for storing video images from the respective plurality of video transmitters. This provides advantages that: surveillance on band-limited multiplexed channels is much faster, without sacrificing the spatial image resolution of the object(s) of interest; images recovered have better perceptual quality; there is higher spatial resolution for the object(s) of interest; there is quick first image display time, and subsequent video frames will be transmitted rapidly. A CCTV system can thus poll multiple video transmitters more quickly.

### FIELD OF THE INVENTION

This invention relates to video/image transmission systems and video/image encoding/decoding techniques. The invention is applicable to, but not limited to, efficient multiplexing of video streams in a low bandwidth communication system.

### BACKGROUND OF THE INVENTION

In the field of this invention it is frequently necessary to transmit images from multiple transmitters to a single receiver, for example in a security surveillance application where one operator may be responsible for multiple camera inputs.

For example, in systems using ITU H.263 [ITU-T Recommendation, H.263, “Video Coding for Low Bit Rate Communication”] video compression, the first frame of the video sequence is transmitted as intra-coded information. The Intra-coded information is followed by faster inter-coded information.

Clearly, in most commercial video systems there exists a bandwidth constraint. In particular, bandwidth is both a critical and valuable commodity in low bandwidth systems, where the intra-coded frame frequently contains a relatively large amount of data. As a consequence, a video transmission that incorporates intra-coded frames takes a relatively long time to transmit.

The first image transmitted in a video sequence is always an intra-coded (I) frame. The I-frame contains data relating to the whole of the image. Due to the large amount of data required in the I-frame, the video system designer often faces a compromise between the spatial quality of the image and the transmission time. This is particularly true for low-bandwidth systems, such as the TErrestrial Trunked RAdio system (TETRA) as defined by the European Telecommunications Standards Institute (ETSI).

Subsequent frames to the I-frame(s) are encoded as predicted (P) frames. The use of prediction with subsequent frames improves the frame rate. P-frames use the temporal similarity between the last transmitted frame and the current frame to reduce the amount of data to be transmitted.

In the context of the present invention, and the indications of the advantages of the present invention over the known art, the expression “video transmission”, as used in the remaining description, encompasses various video techniques. These typically involve real-time, or near real-time, transmission of images at various data rates. The expression of “video” in the subsequent description also encompasses image transmission, which is generally viewed as a one-frame video. Furthermore, the video techniques concerned may, for example, also include video that is streamed, or encoded for storage with the ability for the video images to be viewed later.

Referring first to FIG. 1, there is shown a prior art video communication system 100 employing a block-based codec such as the well-known H.263 set of coding tools. A video signal 110 is provided to a block-based codec 120, which processes the video signal 110 and provides an encoded output signal 140. A rate-control element 130 controls the frame rate and quantisation of the block-based codec 120, thus determining the data bandwidth of the encoded output signal 140.

Therefore, the designer of a video communication system where video images are compressed is left with a dilemma: should the Intra-coded frame (I-frame) be transmitted with low compression to give a good spatial resolution? In making a decision, the designer needs to consider that such an approach causes lengthy video transmission times.

Alternatively, the I-frame may be transmitted with a high degree of compression. However, as such, the resulting image may have a poor spatial resolution, image detail may be of too poor a quality to be recognisable to the recipient, and/or the perceived image quality will be poor. This makes it difficult to extract information from the image.

For the first image to be received and displayed at the decoder, a compromise is frequently adopted between the spatial resolution of the image and the communication delay. This however leads to sub-optimal system performance. For example, a first high compression image may be transmitted with a low delay and the detail filled in with later inter-coded frames. This however, leads to a time delay whilst the image builds up to an acceptable spatial resolution for the user.

In a CCTV surveillance application, multiple cameras transmit video to one or more displays. The encoded data streams will typically be multiplexed such that one data stream arrives at a decoder unit and is decoded using a video decoder, as shown in FIG. 2. Use of a single decoder at the receiver rather than multiple decoders is typical because multiple decoders are: costly; use up valuable equipment space; are wasteful of power; and contain redundancy, as a lot of the processing resources remain unused.

It is also difficult to rapidly adjust capacity up and down as cameras are added to/removed from the video transmission system, because that would require adding/removing extra decoders.

FIG. 2 shows a prior art multiple-encoder single-decoder video/image transmission system 200. The system includes video encoder units 220, 230, 240, each having respective frame stores 225, 235, 245 for storing their respective current reconstructed video/image frame. Three units are shown for clarity purposes only, whereas in a real-life system it is possible to have hundreds and, on rare occasions, thousands of encoding units (cameras).

An encoder unit generates a “reconstructed picture” for each video picture to be transmitted. The reconstructed picture is formed by applying the decoding process to a previously-encoded image. The data to be transmitted by the encoder is formed by applying a discrete cosine transform (DCT), quantization, and Huffman coding to the difference between the current video frame to be transmitted, and an appropriately motion compensated delayed version of the reconstructed picture. Thus, the video encoder units 220, 230, 240 transmit the encoded difference between the incoming respective video images and the motion compensated stored video/image frames 228, 238, 248 to a single video decoder 210 having a single video/image frame store 215.

It is noteworthy that in such typical image transmission systems the encoder does not necessarily encode every incoming frame. To achieve the desired bit rate, some frames are simply dropped. This is why received pictures can be jerky using such prior art methods. Such jerky pictures are caused when there is a long delay between the first I frame and the next available P frame, meaning that a number of intermediate frames have been dropped.

However, in such a case where there is a shared communication channel between multiple video transmitters and a single decoder at the receiver, then each time a video transmitter is selected by the receiver the transmission starts with an Intra-coded (I) frame. Such a mechanism is inefficient, as highlighted below with reference to FIG. 3.

FIG. 3 shows a representation 300 of the system performance of the above prior art video/image transmission system. As shown, the compressed and encoded differences between the frames to be transmitted and the motion compensated reconstructed pictures in the frame store of encoder-1 225 are transmitted 228 in the first time period to the decoder to be decoded to create reconstructed output pictures which are stored in the decoder frame store 215.

Notably, the intra-coded (I) frame takes a significant amount of time to be transmitted and received, in comparison to the transmission slot time available. Consequently, only a limited number of predicted P-frames can be transmitted and received in the transmission slot time. The video decoder output 310 corresponds to the decoder frame store 215.

The compressed and encoded differences between the frame to be transmitted and the motion compensated reconstructed pictures in the frame store of encoder-2 235 are transmitted 238 in the second time period to the decoder to be decoded to create reconstructed output pictures which are stored in the decoder frame store 215. Notably, the intra-coded (I) frame again takes a significant amount of time to be transmitted and received, in comparison to the transmission slot time available. Clearly this limits the number of P-frames sent.

In a similar manner, frame store of encoder-3 245 uses the third time period, before returning to the transmission of the compressed and encoded difference between the next frames to be transmitted and the previous motion compensated reconstructed pictures in the frame store 225 of encoder-1.

Alternatively, if more P-frames are sent, for example using two or more transmission time-slots, the system will suffer from a relatively slow polling rate.

It is also known that a multiplexed video streamed system may suffer from a lower frame-update rate when compared to a direct encoder to decoder video transmitter system. This problem will be apparent in a large number of system configurations, for example, security or surveillance systems over a TETRA system using a circuit-switched or packet-switched mode of data transfer. The problem is further exacerbated if the surveillance system is required to manage a large number, for example in excess of one hundred, video encoders/transmitters. This might be to cover say, a stretch of railway or an airport.

Thus there exists a need in the field of the present invention to provide a video transmission system, a video transmission unit, methods of encoding/decoding video data and a method of polling cameras wherein the above-mentioned disadvantages are alleviated. U.S. Pat. No. 6,038,364, WO-A-01/13639, U.S. Pat. No. 5,724,475, U.S. Pat. No. 4,961,211 are known prior art.

### STATEMENT OF INVENTION

The present invention provides a video transmission system, a video encoder, communication units, video decoder, a method of encoding in a video transmission system, a method of decoding in a video transmission system, a method of polling cameras in a video transmission system, a method of controlling multiple video encoders in a video transmitter system, and a storage medium storing processor-implementable instructions for controlling a processor.

### BRIEF DESCRIPTION OF THE DRAWINGS

FIG. 1 shows a prior art video transmission system employing a block-based encoding/decoding mechanism.

FIG. 2 shows a prior art multiplexed video transmission system.

FIG. 3 shows a representation of the system performance of the prior art video transmission system of FIG. 2.

Exemplary embodiments of the present invention will now be described, with reference to the accompanying drawings, in which:

FIG. 4 shows a multiplexed video transmission system in accordance with a preferred embodiment of the invention.

FIGS. 5a and 5b show a representation of the system performance of the video transmission system of FIG. 4, in accordance with a preferred embodiment of the invention.

FIG. 6 shows a flowchart detailing the operation of an encoder (transmitting video unit) in a multiplexed video transmission system, in accordance with a preferred embodiment of the invention.

FIG. 7 shows a flowchart detailing the operation of a decoder (receiving video unit) in a multiplexed video transmission system, in accordance with a preferred embodiment of the invention.

FIG. 8 shows a block diagram of a decoder (receiving video) unit, in a multiplexed video transmission system, in accordance with a preferred embodiment of the invention.

FIG. 9 shows a timing diagram highlighting a camera-polling mechanism, in accordance with a preferred embodiment of the invention.

FIG. 10 shows a timing diagram highlighting an emergency signalling mechanism, in accordance with a preferred embodiment of the invention.

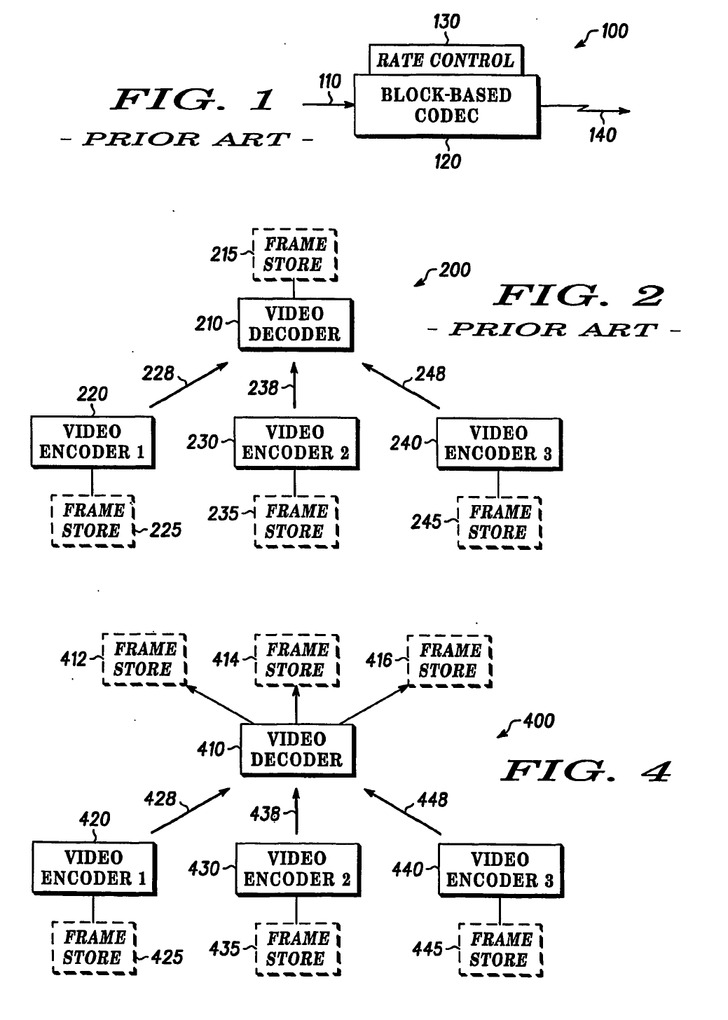

### DESCRIPTION OF PREFERRED EMBODIMENTS

As mentioned above, in a conventional ‘one to one’ video transmission system, the encoder and decoder each have a single frame store that holds the last reconstructed image. By storing the last reconstructed image, the next frame can be predicted from this image (P-Frame), thereby avoiding the need for transmission of the whole of the next frame to the decoder. Such a prediction technique facilitates a higher system frame rate. For prediction to work satisfactorily, clearly both the encoder and decoder frame stores have to contain the same image.

In summary, according to the preferred embodiment of the invention, a mechanism is provided that allows a single decoder to be used at the receiver, independent of the number of transmitting video encoders. However, when a multiple video transmitter, single receiver system is used, the receiver's frame store in a prior art system would only contain the last reconstructed image from the currently selected video transmitter. This would result in the need to transmit an I-frame each time the multiplexer selects a new video transmitter.

This potential problem is resolved in the present invention by the provision of a number of frame stores at the decoder, for example one per encoder/video transmitter. Thus, the decoding unit is able to immediately resume a video link with any encoding unit, by returning to the last reconstructed frame. By returning to the last reconstructed frame, the faster P-frames can be sent immediately.

Advantageously, this avoids the need to transmit a new I-frame each time a video link is re-connected. Consequently, such a mechanism enables the video transmission system to operate at a higher frame rate and/or a faster polling time, compared to a video transmission system having to transmit I-frames each time.

Furthermore, the present invention provides a preferred means of controlling multiple video encoders such that when each encoder has either reached the end of its allocated transmission time, or is interrupted by another camera/encoder with higher priority, the latest reconstructed frame is stored. No further processing takes place until this transmitter is instructed to start transmission again. This ensures that the encoder and decoder frame stores remain in synchronisation and always contain exactly the same last-reconstructed frame.

In order to maintain maximum picture quality, the system must ensure that the stored frame in the encoder exactly matches that in the corresponding decoder frame store. The synchronisation mechanism is achieved by ensuring the encoder and decoder return to the previous “reconstructed” frame say, after an interruption in the video transmission sequence. Synchronisation is achieved by the respective encoder and the single decoder tracking, for example by the frame number and/or the absolute timing of the particular last-reconstructed frame for that video link, or other means.

For example, assume that camera N was transmitting compressed video data to the decoder. The control mechanism for the system may be set to allow each camera to transmit for p seconds each time it is polled. Thus, camera N starts a timer when it receives the signal from the system control that it has permission to start transmitting. When the timer reaches p seconds, camera N stops encoding, and freezes the last reconstructed picture in its frame store.

At the decoder, a timer is started each time a change of transmitting camera occurs. After p seconds have elapsed, the decoder freezes the last reconstructed picture in its frame store, and prepares to start decoding from camera N+1.

However, it is within the contemplation of the invention that alternative synchronisation mechanisms can be used, such as allowing a defined number of frames from each camera to be transmitted during a polling slot (variable time) using reconstructed frame number as a reference, or controlling the time and/or number of frames that can be transmitted by an external control mechanism.

In normal polling operation, in the preferred embodiment of the invention, a camera may receive instructions on a control channel to end a transmission. At this moment, the encoder must freeze acquisition of source images, and process the data remaining in its buffers. The transmission system must allow this final data to take priority, such that the decoder may update the appropriate frame store, and this also remains frozen.

If an interruption occurs, for example in an emergency situation where an encoder out of sequence has to be viewed by an Operator, the system needs to be able to rapidly determine which frame store the decoder should access when receiving new information from the transmitter. This is critical in a high performance system where there may be, for example, in excess of one hundred cameras to poll. The mechanism according to the preferred embodiment of the invention avoids the need to transmit I-frame data.

Referring now to FIG. 4, a multiplexed video transmission system 400 is shown in accordance with a preferred embodiment of the invention. The system includes video encoder units 420, 430, 440, each having respective frame stores 425, 435, 445 for storing the reconstructed picture relating to their respective current video/image frame. Three units are shown for clarity purposes only.

In turn, the video encoder units 420, 430, 440 transmit the encoded difference between the incoming respective video images and the motion compensated respective stored video/image frame 428, 438, 448 to a single video decoder 410.

Notably, in accordance with the preferred embodiment of the invention, the single video decoder 410 includes a plurality of video/image frame stores 412, 414, 416. Each of the plurality of video/image frame stores 412, 414, 416, maintains the last re-constructed frame that was decoded from the compressed and encoded data transmitted by the respective transmission unit/encoder.

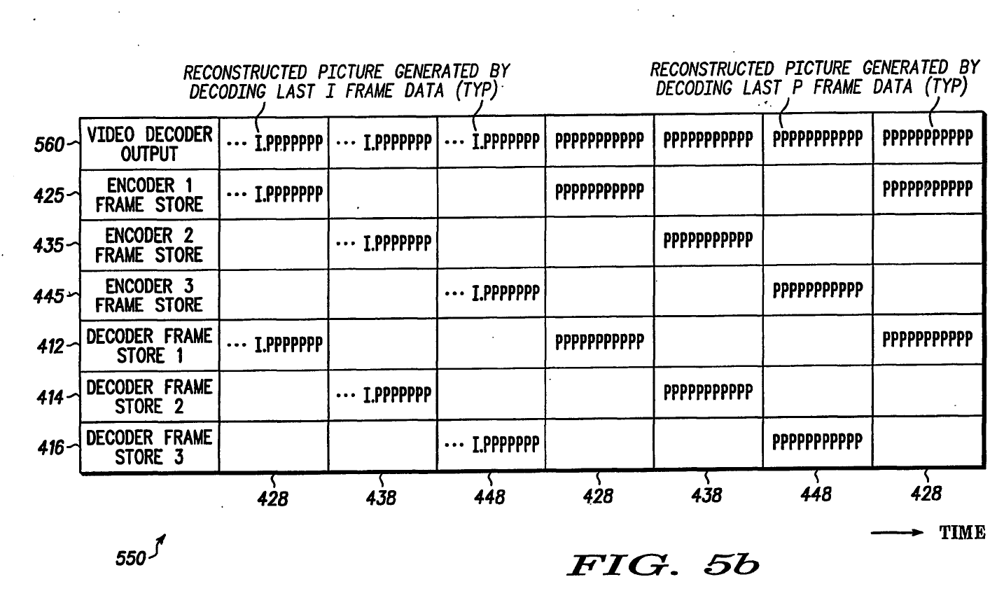

In using a plurality of video/image frame stores 412, 414, 416, at the single video decoder 410, the previous prior art requirement of commencing all transmissions within the polling sequence with an intra-coded frame is avoided. Such a mechanism is much more efficient, as highlighted below with reference to FIG. 5a.

Referring now to FIG. 5a, a representation 500 of the system performance of the above video communication system is shown. As shown, the compressed and encoded differences between the frames to be transmitted and the motion compensated reconstructed pictures in the frame store of encoder-1 425 are transmitted 428 in the first time period to the decoder to be decoded to create reconstructed output pictures which are stored in the decoder frame store 412.

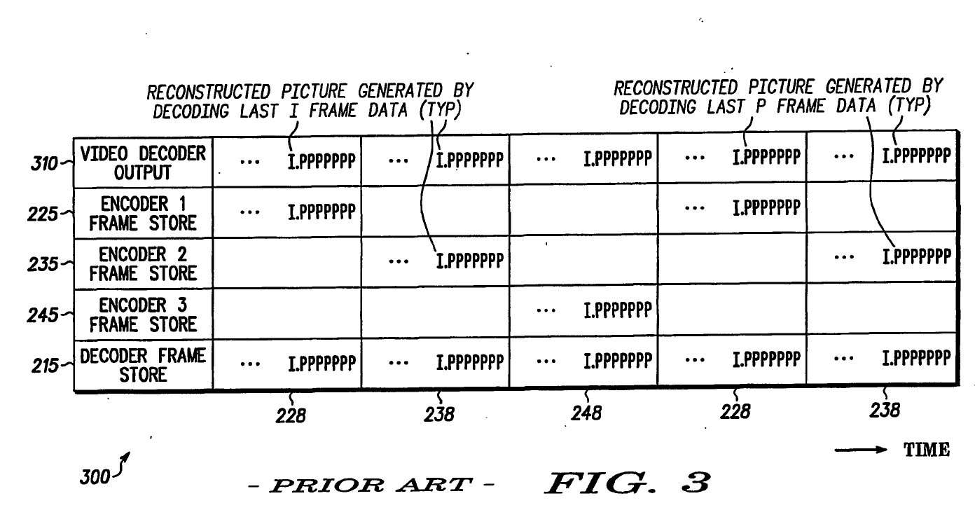

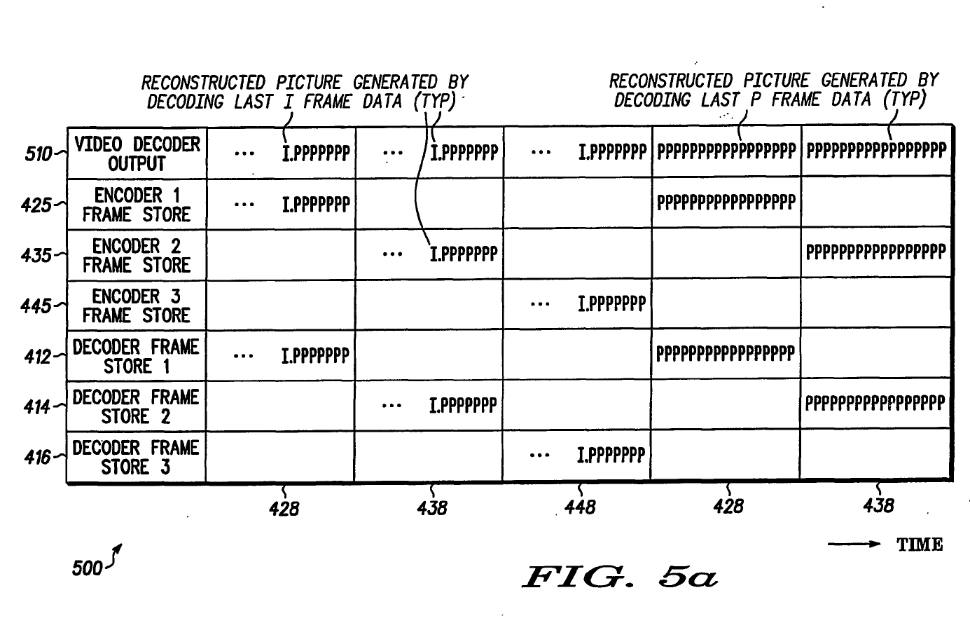

Notably, once polling has been established, the first frame of any time-slot takes a greatly reduced amount of time to be transmitted and received, as it is a P-frame rather than an I-frame, in comparison to both the transmission slot available and the prior art mechanism described with reference to FIG. 3. Consequently, a greatly increased number of predicted P-frames are transmitted and received in the transmission slot. The video decoder output 510 corresponds to the respective decoder frame store—frame store-1 412, frame store-2 414 or frame store-3 416.

As shown, the compressed and encoded differences between the frames to be transmitted and the motion compensated reconstructed pictures in the frame store of encoder-2 435 are transmitted 438 in the second time period to the decoder to be decoded to create reconstructed output pictures which are stored in the decoder frame store-2 414.

Similarly, the compressed and encoded differences between the frames to be transmitted and the motion compensated reconstructed pictures in the frame store of encoder-3 445 are transmitted 448 in the third time period to the decoder to be decoded to create reconstructed output pictures which are stored in the decoder frame store-3 416. As before, the mechanism then returns to the transmission of the compressed and encoded difference between the next frame to be transmitted and the previous motion compensated reconstructed picture in the frame store 425 of encoder-1.

Notably, the encoder and decoder are synchronised in the preferred embodiment of the invention. As such, the encoders do not continue to transmit frames that will not be processed by the decoder.

After the initial poll sequence, where an intra-coded (I) frame is sent, each time a video transmitter is re-selected, a much larger number of P frames will be displayed from each encoder. The number of P frames will depend on a number of factors one of which is the time slot length. Hence, when applying the inventive concepts of the present invention to existing image transmission systems, the time slot length may be chosen to be a convenient number, for example two TETRA multi-frames (2×1.02 seconds).

The next encoder in the sequence then transmits their respective P-frames for processing and displaying at the decoder before the next video transmitter is selected, as shown in FIG. 5a.

Beneficially, this additional number of transmitted P-frames, when compared to prior art arrangements, will perceptually present to the user a series of video clips in contrast to a series of ‘stills’ followed by a small amount of ‘jerky’ video.

FIG. 5b shows an alternative method that takes advantage of the inventive concepts of the present invention. The method follows the initial I-frame transmission sequence described with reference to FIG. 5a. However, advantageously, the time per video transmitter time-slot 428, 438, 448 for subsequent transmission of P-frames has been reduced to less than the time required to transmit an I-frame, in this example to 1.02 seconds (equivalent to a TETRA multi-frame time period).

Each video transmitter is able to transmit multiple P-frames in this reduced time. An advantage with this alternative embodiment is that a faster poll time can be achieved compared to a video transmission system that does not employ this invention. The faster poll time is achieved whilst still maintaining a series of video clips presented to the user. Furthermore, with such flexibility in the setting of such P-frame time periods, the alternative method can be superimposed on, or adapted to fit in with, any timing structure.

To quantify the benefits of employing the aforementioned inventive concepts in a real-life video-transmission system, let us consider an example TETRA-based system. Known video formats include common intermediate format (CIF) using 352×288 pixels, and quarter common intermediate format (QCIF) using 176×144 pixels.

For example, a TETRA-based system may allocate a data rate of 19.2 Kbits/s to the compressed video data, a QCIF image with a target frame rate of ten frames per second (fps) and a target Q of 12. As a result of simulation work, the inventors of the present invention have determined that, using the “hall monitor” sequence (representative of a security application as known to those skilled in the art), the time taken for transmitting an I-frame is 1108 msecs and for an average P-frame is 116 msecs.

Thus, the multiplexer in a TETRA-based polled CCTV system could allow 2.04 seconds (equivalent to two TETRA multi-frames) per video transmitter before moving on to the next video transmitter in the sequence. A prior art TETRA system, not employing this invention, would contain an I-frame and up to 8 P-frames in two TETRA multi-frames. In reality there will be fewer than eight P-frames because straight after an I-frame the P-frames generally contain more data. In employing the concepts in this invention, 17 P-frames may be transmitted in the allocated time, thereby giving a user more comprehensive data from each video transmitter.

In some cases, a faster multiplexing mode may be achieved by implementing a change-detection parameter. The encoder does not transmit any new differential information if a change, determined between the currently viewed frame and the stored frame, is below a predetermined threshold. The faster multiplexing mode can be achieved by the encoder sending an end marker to the decoder without any preceding data. The receiving end treats this case as if it had signalled that camera to stop transmitting and had subsequently received an acknowledgement. The receiving end then signals to the next camera in the polling list to start encoding and transmitting.

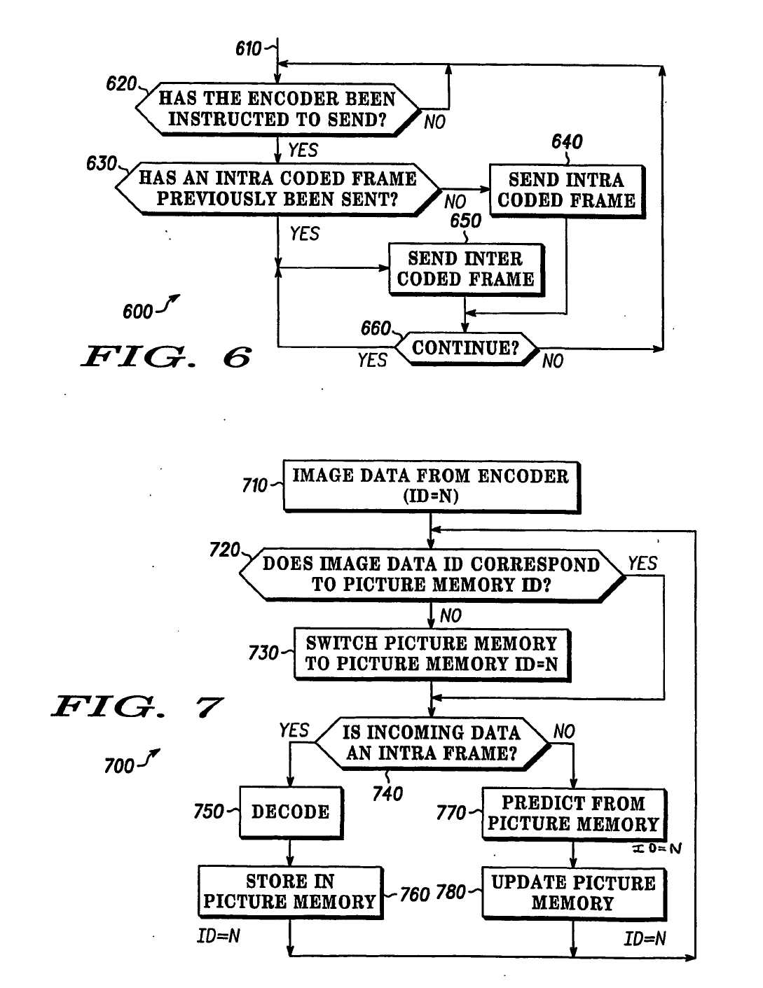

Referring now to FIG. 6, a flowchart 600 detailing the operation of an encoder (transmitting video unit) in a multiplexed video communication system is shown, in accordance with a preferred embodiment of the invention. The operation of the encoder commences with the encoder receiving a video/image frame sequence 610.

In prior art systems (which inherently require a multiplexer), the encoder, when selected, would immediately transmit an Intra-coded frame, followed by inter-coded frames. However, in accordance with the preferred embodiment of the invention, the encoder first determines, in step 620, whether it has been instructed to transmit a video/image frame sequence 610 to the decoder. Steps 620 and 660 ensure that the transmitting and receiving frame buffers contain the same data.

If the particular encoder determines that it has been instructed to transmit video/image frame sequences to the decoder, in step 620, the encoder checks to see whether an Intra-coded frame has already been transmitted to the decoder, as shown in step 630. If an Intra-coded frame has not been transmitted to the decoder in this session, in step 630, an Intra-coded frame is transmitted to initiate the transmissions, as in step 640.

Notably, a session in the context of the preferred embodiment of the invention does not mean a continuous, uninterrupted transmission of a video sequence. A ‘session’ encompasses lengthy periods where the encoder will not have transmitted video update information. Hence, a new session may be defined as being required when a time period since the last transmission exceeds a threshold or a comparison between the present encoder video frame and the last frame stored requires an Intra-coded frame to be re-sent.

Subsequent transmission of Inter-coded frames, i.e. P-frames, are then transmitted to the decoder, as shown in step 650, in accordance with the preferred arrangement described with reference to FIG. 5a or FIG. 5b. The process is then reviewed to see whether it should continue, based on instructions from the decoder unit or other controlling mechanism, as shown in step 660. If the process is to continue, further Inter-coded frames are sent, in step 650. If the transmissions are to stop, say due to an emergency interrupt request from another video encoding unit, the process returns to step 620.

Referring now to FIG. 7, a flowchart 700 is shown detailing the operation of a decoder (receiving video unit), in a multiplexed video communication system, in accordance with a preferred embodiment of the invention.

Compressed and encoded video/image data is received from encoder unit (or camera) N, as shown in step 710 where the reference ID is N. The video/image data ID is then checked to see if it corresponds to the ID of the currently available reconstructed picture being used for decoding of incoming data, step 720. If it does not, then the decode process has an interim step where the stored picture memory is switched to the frame store corresponding to the ID of the data being received, as shown in step 730.

As an example, assume the decoder is currently decoding image data relating to camera (or encoder) N+3. In step 720, the received data ID of N is checked and found not to correspond with the reconstructed picture being used for decoding. Therefore, in step 730, the reconstructed stored image from the frame store with ID=N is used, instead of that from the frame store with ID=N+3.

The incoming data is then checked in step 740 to determine whether it is an Intra-coded frame. If the incoming data is an Intra-coded frame, it is decoded, in step 750 and the decoded picture stored in the picture memory for ID=N, as shown in step 760. The process then returns to step 720.

If the incoming data is determined not to be an Intra-coded frame in step 740, a predicted frame is generated from the picture stored in memory, with the addition of the P-frame data having ID=N, in step 750. The predicted picture is then used to update the picture stored in the memory for the particular ID=N, as shown in step 780. The process then returns to step 720.

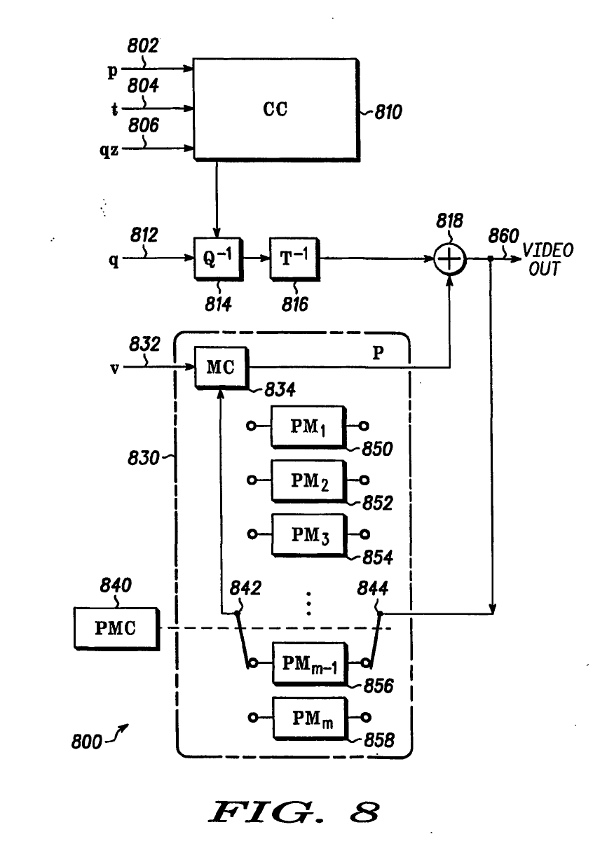

Referring now to FIG. 8, a block diagram is shown of an example H.263 decoder (receiving video unit) 800 in a multiplexed video communication system adapted in accordance with a preferred embodiment of the invention.

However, it is within the contemplation of the invention that such inventive concepts can be applied to any video or image transmission system.

Multiple video/image frames are input to multiple encoders (not shown). An encoding control block in accordance with the preferred embodiment of the invention has been adapted to force each encoder to perform either an Intra-coded or an inter-coded encoding process, as per FIG. 6.

Of particular note in the preferred embodiment of the invention is the introduction of a codec (encoder)-enable function (not shown) that dictates the operation of the coding control block. The codec-enable function has been introduced to ensure that the frame stores at the encoder and decoder stay in step, when the decoder does not want to receive the video/image frame from that particular encoder unit.

More generally, the aforementioned adaptation may be implemented in the respective communication units in any suitable manner. For example, new apparatus may be added to a conventional communication unit, or alternatively existing parts of a conventional communication unit may be adapted, for example by reprogramming of one or more processors therein. As such the required adaptation may be implemented in the form of processor-implementable instructions stored on a storage medium, such as a floppy disk, hard disk, PROM, RAM or any combination of these or other storage media.

In FIG. 8, the decoder 800 includes a decoding control block 810 that receives a flag ‘p’ 802 from the encoding unit, indicating whether the received frame is an Intra-coded or inter-coded frame.

In accordance with the H.263 standard, the decoder 800 receives a quantizing index in order to transform received coefficients ‘q’ 812. The quantizing index is input to an inverse quantizer function 814 and the quantised values input to inverse transform block 816. The inverse quantizer function 814 receives a control signal from the decoder control block 810.

The output from the inverse transform block 816 is input to a summing junction 818. The summing junction 818 also receives an input from the functional block 830 that performs a picture generation with motion compensated variable delay. In particular, the functional block 830 includes a motion compensation block 834 that receives the motion vector ‘v’ 832, transmitted from the encoder unit. The motion compensation block 834 provides picture generation with motion compensated delay to the summing junction 818.

In accordance with the preferred embodiment of the invention, the picture memory storage has been adapted to incorporate individual picture memory (PM) blocks 850, 852, 854, 856, 858, for generating the separate reconstructed images associated with the different encoder units. The relevant PM function is selected by switches 842, 844. The overall picture memory selection process is controlled by picture memory control (PMC) 840.

There is one PM per encoder in the system. The relevant PM is switched into circuit under the control of PMC. The PMC knows which PM to switch in according to the predefined multiplexer strategy or control. This allows each encoder, when reselected, to transmit P-frames rather than having to start each time slot with an I-frame. The old data contained in the PMs enables this to happen.

More generally, the adaptation may be implemented in the respective communication unit(s) in any suitable manner. For example, new apparatus may be added to a conventional communication unit, or alternatively existing parts of a conventional communication unit may be adapted, for example by reprogramming of one or more processors therein. As such the required adaptation may be implemented in the form of processor-implementable instructions stored on a storage medium, such as a floppy disk, hard disk, PROM, RAM or any combination of these or other storage media.

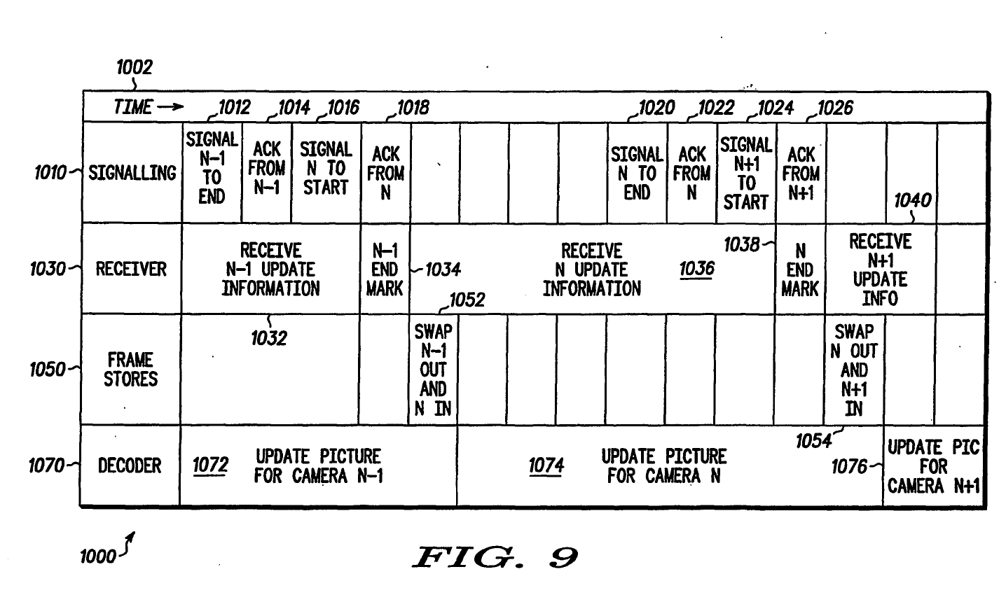

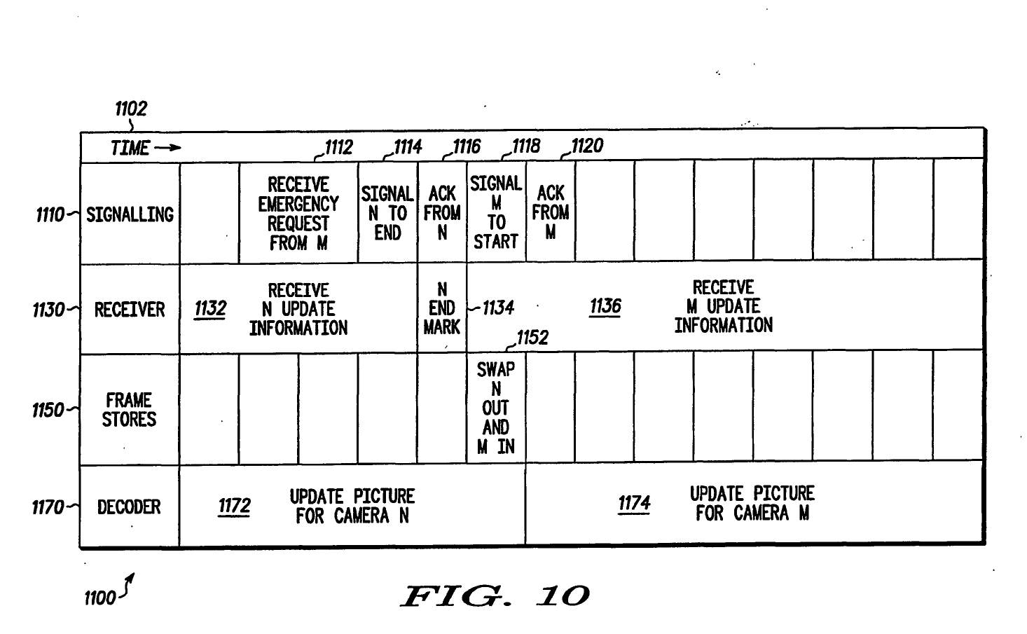

Referring now to FIG. 9, a timing diagram 1000 is shown of a preferred method for a decoder to control a polling operation of a number of camera transmissions. In particular, an example of the interaction, on a time-basis 1002, between the signalling 1010, receiver operation 1030, video frame store control 1050, and the video decoder 1070 is shown. The interaction enables a faster, correct management of the video data.

A skilled artisan would recognise that several different multiplexer strategies are available to make use of this invention. The following is therefore only given as an example.

Let us assume that the video transmission system is polling through cameras ‘N−1’ to ‘N+1’. The decoder/receiver 1030 receives update information 1032 from the ‘N−1’ camera. When the decoder, for example controlled automatically by a rule or chosen dynamically by an operator, decides to change the display from camera ‘N−1’ to camera ‘N’, camera ‘N−1’ is signalled to stop encoding and stop transmitting 1012. Once the encoder end receives this request to stop encoding and transmitting, it sends an acknowledgement 1014 that transmission of the particular video transmission has finished.

As soon as the receiver signalling system detects the acknowledgement from camera ‘N−1’, then it signals to camera ‘N’ to start encoding and transmitting 1016. During this period, camera ‘N−1’ is flushing its buffers and sending the final update information, where the end of its video update data is indicated by an end marker 1034. A small amount of delay is included in the encoder transmission system to ensure that camera ‘N’ does not start transmitting until camera ‘N−1’ has transmitted its end marker.

The process then repeats with the signalling channel being used to start the ‘N’th camera 1016, until the encoder unit receives a message to stop encoding and transmitting and sends its respective end-transmission acknowledgement 1022 to the decoder. The ‘N+1’th camera is then controlled by the signalling channel 1024, 1026.

Once the receiver completes its updating of the ‘N−1’ camera information, by detecting the end marker 1034 for camera ‘N−1’, the decoder transfers its current reconstructed picture into the ‘N−1’ frame store 1052. The decoder has then completed updating the picture for camera ‘N−1’ 1072. Information received following the end marker 1034 relates to updated information for camera ‘N’.

The decoder loads the last reconstructed picture from frame store ‘N’ 1052 (described in FIG. 9 as “swap ‘N−1’ out and ‘N’ in”). The decoder then commences receiving the update information from the ‘N’th camera 1036, 1074.

Once the receiver completes its updating of the ‘N’th camera information 1038, the frame store update in the decoder is switched from ‘N’ to ‘N+1’ 1054. Such a switch ensures that the decoder's latest picture is moved to the ‘N’th frame store 1074 and the ‘N+1’th decoder frame store is loaded. The decoder has then completed updating the picture for camera ‘N’ 1074, and then commences receiving the update information from the ‘N+1’th camera 1040, 1076.

Alternatively, known system timing points can be used as trigger points for the change over of video data streams. The current reconstructed frame is frozen in the encoder frame store for say, camera ‘N−1’, and this camera does not carry out any further processing until signalled to do so when it is next polled.

It is important that the decoder can access the appropriate frame store in the fastest possible time. Preferably a shared addressable bus is used such that each frame store corresponding to each camera has a unique address. In a polling mode, the address simply increments as each camera is polled in turn. However, if an emergency occurs and one camera is suddenly assigned priority out of turn, a means of signalling which camera is transmitting will be required, an example of which is shown in FIG. 10.

Referring now to FIG. 10, a control mechanism for emergency camera transmissions 1100 is shown. In particular, the emergency signalling control mechanism is described, on a time-basis 1102, highlighting the interaction between the signalling 1110, receiver operation 1130, video frame store control 1150, and the video decoder 1170 is shown. The interaction enables a faster, correct management of the video signal.

If, at any time, the signalling system (say of FIG. 9) receives an emergency request 1112 from camera ‘M’ whilst camera ‘N’ is updating, the decoder signals to camera ‘N’ to end its transmission 1114 (as if camera ‘N’ had reached the end of its polled transmission). Signalling camera ‘N’ to stop its transmissions overrides any automated (timed) activity. As soon as the acknowledgement 1116 is received at the decoder, camera ‘M’ is signalled 1118 to start encoding and transmitting. Operation may now proceed as described for the polled case, albeit that the frame stores are now accessed “out of turn”.

The picture from camera ‘N’ is updated 1172 with received update information 1132, until the decoder receives the end mark message 1134. Update information from camera ‘M’ 1136 is then received and processed. With regard to the decoder accessing the respective frame stores, “swap ‘N’ out and ‘M’ in” 1152 ensures that the decoder's latest picture is moved to ‘N’ frame store and the decoder uses a frame store corresponding to M. The picture for camera ‘M’ is then updated 1174.

A preferred emergency control mechanism could use an address look-up-table that links the camera address, for example an IP address in the case of WebCams, with the decoder frame store number. If cameras are added to or removed from the system, the look-up-table can be dynamically updated, making this a very flexible system.

The inventive concepts described herein have significant impact on the development and design of video and image encoders for band-limited multiplexed video security applications—in particular over wireless communication channels.

Furthermore, the inventive concepts described herein are applicable to any video compression system that uses predictive coding, for example H.263, H.261, MPEG-4, Motion-JPEG. The implementation is standards compliant, as the bit-stream is not altered, but intelligently controlled. The method is applicable to wired and wireless systems, and has the benefit over existing and obvious solutions of offering cost savings and enhanced performance to the user. The invention may be applied to video compression systems operating according to the 3G standard, a 4G protocol, or any other compression method that uses inter- and intra-frames.

In summary, a video transmission system has been provided having a plurality of video transmitters. Each video transmitter transmits at least one respective video image, and at least one video receiver receives video images from the plurality of video transmitters. The at least one video receiver has a plurality of frame stores for storing video images from the respective plurality of video transmitters. The video receiver receives a compressed and encoded video image from the respective video transmitter.

Furthermore, a video encoder has been described having a receiver for receiving a video image for encoding and transmitting said to a video decoder. The video encoder is operably coupled to a coding control block that initiates transmission of a single Intra-coded video frame, followed by subsequent transmission of predicted frames. Such subsequent predicted frames being the only transmitted frames irrespective of whether there is an interruption in the video transmission.

A video decoder has been provided having a receiver for receiving video images operably coupled to a plurality of frame stores for receiving and storing a plurality of reconstructed video images generated from compressed and encoded transmitted images from a plurality of video transmitters.

A communication unit, adapted to incorporate the aforementioned video encoder or the aforementioned video decoder or adapted to operate in the aforementioned communication system has also been described.

A method of encoding in a video transmission system has also been described. The method includes the steps of: determining, by an encoder, as to whether the encoder has been instructed to transmit a video/image frame sequence to a decoder. If the encoder determines that it has been instructed to transmit a video sequence to the decoder, the steps include checking, by the encoder, whether an Intra-coded frame has previously been transmitted to the decoder; and sending an Intra-coded frame to the decoder if one has not been transmitted for that session. Otherwise the step includes transmitting Inter-coded frames to the decoder.

In addition, a method of decoding in a video transmission system has been described. The method includes the steps of: receiving a compressed and encoded video sequence from a video encoder; determining a camera or encoder reference indication of the received video sequence; and checking, by a decoder, to see if said determined reference indication corresponds to the reference indication of the stored picture memory being used for the current decoding. The step also includes switching the picture memory being used for processing by the decoder, if the reference indication does not correspond to said stored picture memory.

A communication unit, adapted to perform the aforementioned method of encoding or the aforementioned method of decoding has also been described.

A method of polling cameras in a video transmission system has also been described. The video transmission system includes a plurality of encoding video transmission cameras and at least one decoding video receiving unit.

The method includes the steps of: receiving, into one of a plurality of frame stores at the decoding video receiving unit, picture update information (1032) transmitted from a first camera; signalling, by the decoding video receiving unit, to the first camera to stop encoding video images and stop transmitting a video sequence; signalling, by the decoding video receiving unit, to a second camera to start encoding and transmitting; and receiving, into another of the said plurality of frame stores, picture update information transmitted from the second camera.

A method of controlling multiple video encoders in a video transmitter system has been described. The method includes the steps of: storing a latest reconstructed frame from each camera, such that subsequent transmissions from a camera are based on said stored latest reconstructed frame from that camera, the step of storing a latest reconstructed frame being in response to either: an encoder reaching an end of its transmission time or interrupting a video transmission of an encoder of a first camera by a second camera with higher priority.

A communication unit adapted to perform the method steps of polling cameras and/or adapted to perform any of the method of controlling multiple video encoders has also been described.

In addition, a storage medium storing processor-implementable instructions for controlling a processor to carry out any of the aforementioned method steps has been described.

It will be understood that the video transmission system, video transmission unit and methods of encoding/decoding video data described above provide at least the following advantages:

(i) surveillance on band-limited multiplexed channels is much faster, without sacrificing the spatial image resolution of the object(s) of interest;

(ii) images recovered at the decoder have a better perceptual quality, as there is significantly less subjective temporal jerkiness as a consequence of lower transmission delays;

(iii) for image/video transmission systems where a CIF image is preferred to a QCIF image, the mechanism proposed herein is much faster;

(iv) the user/image/video Operator will benefit from:

(a) high spatial resolution for the object(s) of interest,

(b) a quick first image display time once polling is established, due to the reduced amount of data to be transmitted, and

(c) subsequent first video frames will be transmitted much faster than a prior art system would allow. This enables faster polling through a given number of cameras. Alternatively, more subsequent image frames can be received in an allocated time allowed to each camera in a polled system.

(v) enables cameras to be switched seamlessly in/out of their normal sequence whilst still maintaining the aforementioned benefits of this invention.

Thus, a video transmission system, a video transmission unit and methods of encoding/decoding video data and a method of polling cameras have been provided wherein the abovementioned disadvantages with prior art arrangements have been substantially alleviated.

1. A method of encoding in a video transmission system, the method comprising the steps of:
an encoder determining whether the encoder has been instructed to transmit a video/image frame sequence to a decoder; and
if the encoder determines that it has been instructed to transmit a video sequence to the decoder,
the encoder checking whether an Intra-coded frame has previously been transmitted to the decoder;
sending an Intra-coded frame to the decoder if one has not been transmitted for that session; and
otherwise, transmitting Inter-coded frames to the decoder.

2. The method of encoding in a video transmission system according to claim 1, the method further comprising the step of the encoder waiting for instructions to be transmitted from the decoder, or other control mechanism, for the encoder to stop encoding the current video sequence.

3. A communication unit adapted to perform the method of encoding according to claim 1.

4. A method of decoding in a video transmission system, the method comprising the steps of:
receiving a compressed and encoded video sequence from a video encoder;
determining a camera or encoder reference indication of the received video sequence;
a decoder checking to see if said determined reference indication corresponds to the reference indication of the stored picture memory being used for the current decoding; and
switching the picture memory being used for processing by the decoder, if the reference indication does not correspond to said stored picture memory.

5. The method of decoding in a video transmission system according to claim 4, the method further comprising the steps of:
the decoder checking a received video frame to determine whether it is an Intra-coded frame; and either
storing a decoded picture in a frame store associated with the encoding unit if the received video frame sequence was determined as an Intra-coded frame; or
generating a predicted video frame from a picture stored in memory, if the received video frame sequence is determined not to be an Intra-coded frame and updating a picture stored in memory using the predicted picture.

6. A method of encoding in a video transmission system according to claim 1, wherein the video transmission system is a multiplexed video transmission system.

7. A communication unit adapted to perform the method of decoding according to claim 4.

8. A method of polling cameras in a video transmission system having a plurality of encoding video transmission cameras and at least one decoding video receiving unit, the method comprising the steps of:
receiving, into one of a plurality of frame stores at the decoding video receiving unit, picture update information transmitted from a first camera;
the decoding video receiving unit signalling to the first camera to stop encoding video images and stop transmitting a video sequence;
the decoding video receiving unit signalling to a second camera to start encoding and transmitting; and
receiving, into another of the said plurality of frame stores, picture update information transmitted from the second camera.

9. The method of polling cameras according to claim 8, further comprising the step of the first camera sending the final update information, the step including sending an end marker to identify an end of its video update data.

10. The method of polling cameras according to claim 9, the method further comprising the steps of:
detecting the end marker transmitted by the first camera; and
the decoder transferring its current reconstructed picture into the frame store associated with the first camera.

11. The method of polling cameras according to claim 8, the method further comprising the steps of:
the decoder loading the last reconstructed picture from the frame store associated with the second camera; and
receiving update information from the second camera.

12. The method of polling cameras according to claims 8, the method further comprising the steps of:
the first camera responding with an acknowledgement that transmission of the particular video transmission has finished; and
receiving at the decoder the acknowledgement from the first camera.

13. The method of polling cameras according to claim 8, the method further comprising the step of flushing of the first camera memory buffers in both the encoding unit and video decoding unit after completing transmission of the video sequence.

14. A communication unit adapted to perform the methods of polling cameras according to claims 8.

15. A method of controlling multiple video encoders in a video transmitter system, the method comprising the step of storing a latest reconstructed frame from each camera, such that subsequent transmissions from a camera are based on said stored latest reconstructed frame from that camera, the step of storing a latest reconstructed frame being in response to either:
an encoder reaching an end of its transmission time; or
interrupting a video transmission of an encoder of a first camera by a second camera with higher priority.

16. The method of controlling multiple video encoders in a video transmitter system according to claim 15, the method further comprising the steps of:
receiving an emergency request from a second camera whilst video images from a first camera are being updated;
the decoder signalling a request to the first camera to stop its video transmissions;
sending an acknowledgement of receipt of said signalling request to the decoder; and
signalling to said second camera to start encoding and transmitting its video sequence.

17. The method of controlling multiple video encoders in a video transmitter system according to claim 15, the method further comprising the methods of polling according to claims 8.

18. A communication unit adapted to perform the method (700) of controlling multiple video encoders according to claim 15.

19. A storage medium storing processor-implementable instructions for controlling a processor to carry out the method of claim 1.

20. A video transmission system comprising:
a plurality of video transmitters, each video transmitter transmitting at least one respective video image;
at least one video receiver, for receiving video images from the plurality of video transmitters, the at least one video receiver having a plurality of frame stores, for storing video images from the respective plurality of video transmitters, the video receiver receiving a compressed and encoded video image from the respective video transmitter.

21. The video transmission system according to claim 20, wherein the number of frame stores in the video receiver is substantially equal to the number of video transmitters.

22. The video transmission system according to claim 20, the video receiver including a processor for reconstructing the latest frame used by the respective video transmitter for generating the data transmitted, and storing said latest reconstructed frame in a video frame store associated with said respective video transmitter.

23. The video transmission system according to claim 22, wherein the latest reconstructed frame from a video transmitter is stored when either the respective video transmitter has reached the end of its transmission time, or the transmission from the respective video transmitter is interrupted by another camera with higher priority.

24. The video transmission system according to claim 22, further characterised by said processor delaying reconstructing video images transmitted from said respective video transmitter until the respective video transmitter is signalled from the video receiver to re-commence video transmissions.

25. The video transmission system according to claim 20, wherein the plurality of video transmitters transmit a single Intra-coded video frame, followed by subsequent transmission of predicted frames, irrespective of whether there is an interruption in the transmission.

26. The video transmission system according to claim 25, wherein the Intra-coded frame is transmitted in a predetermined time-slot, and subsequent predicted frames are transmitted in a shorter time-slot than that allocated for the Intra-coded frame.

27. The video transmission system according to claim 20, wherein the plurality of encoders and the at least one decoder are synchronised by communicating therebetween either the frame number and/or an absolute transmission timing of a respective last-reconstructed frame.

28. A video encoder comprising a receiver for receiving a video image for encoding and transmitting said video image to a video decoder, the video encoder being operably coupled to a coding control block, said coding control block initiating transmission of a single Intra-coded video frame, followed by subsequent transmission of predicted frames, such subsequent predicted frames being the only transmitted frames irrespective of whether there is an interruption in the video transmission.

29. A communication unit adapted to incorporate a video encoder according to claim 28.

30. A video decoder comprising a receiver for receiving video images, operably coupled to a plurality of frame stores for receiving and storing a plurality of reconstructed video images generated from compressed and encoded transmitted images from a plurality of video transmitters.

31. The video decoder according to claim 30, further characterised by a picture memory controller for controlling the overall picture memory selection process.

32. The video decoder according to claim 30 or claim 31, wherein the video decoder is adapted to operate according to the H.263 standard, the MPEG-4 standard, the 3G standard, a 4G protocol, or any other compression method that uses inter- and intra-frames.

33. A communication unit adapted to incorporate a video decoder according to claims 30.

34. A method of decoding in a video transmission system according to claim 4, wherein the video transmission system is a multiplexed video transmission system.

35. A storage medium storing processor-implementable instructions for controlling a processor to carry out the method of claim 8.

36. A storage medium storing processor-implementable instructions for controlling a processor to carry out the method of claim 15.

37. A communication unit adapted to operate in the communication system of claim 20.
